(19) United States
(12) Patent Application Publication
(10) Pub. No.: US 2010/0293223 A1
(43) Pub. Date: Nov. 18, 2010

(54) LIMITING STORAGE MESSAGES IN PEER TO PEER NETWORK

(75) Inventors: Manish Bhardwaj, San Jose, CA (US); Jining Tian, Cupertino, CA (US)

Correspondence Address: Patent Capital Group - Cisco, 6119 McCommas, Dallas, TX, 75214, US

(73) Assignee: CISCO TECHNOLOGY, INC.

(21) Appl. No.: 12/467,849

(22) Filed: May 18, 2009

(51) Int. Cl. G06F 15/16; G06F 15/173

(52) U.S. Cl. 709/203; 709/205; 709/223

(57) ABSTRACT

In system of DHT rings that are not filly meshed with each other, flooding of PUT and GET messages is limited by PUTting a content key indicating an actual storage location of content from a content provider only to root DHTs associated with the content provider, and PUTting a secondary key indicating a subset of DHT rings at which content from the content provider might be stored only to DHT rings for which the content provider desires the content to be available. When a DHT receives a GET it first determines from the content key whether it can provide the content and if not, the DHT obtains the subset of DHT rings from the secondary key and forwards the GET of the content key to the corresponding root DHTs.

### FIELD OF THE INVENTION

The present application relates generally to peer-to-peer networks and more particularly to limiting broadcast flooding of storage messages.

### BACKGROUND OF THE INVENTION

A peer-to-peer network is an example of a network (of a limited number of peer devices) that is overlaid on another network, in this case, the Internet. In such networks it is often the case that a piece of content or a service desired by one of the peers can be provided by more than one other node in the overlay network.

An example peer to peer network may include a network based on distributed hash tables (DHTs). DHTs are a class of decentralized distributed systems that provide a lookup service similar to a hash table: (name, value) pairs are stored in the DHT, and any participating node can efficiently retrieve the value associated with a given name. Responsibility for maintaining the mapping from names to values is distributed among the nodes, in such a way that a change in the set of participants causes a minimal amount of disruption. This advantageously allows DHTs to scale to extremely large numbers of nodes and to handle continual node arrivals, departures, and failures. DHTs form an infrastructure that can be used to build more complex services, such as distributed file systems, peer to peer file sharing and content distribution systems, cooperative web caching, multicast, anycast, domain name services, and instant messaging.

### BRIEF DESCRIPTION OF THE DRAWINGS

The details of the present disclosure, both as to its structure and operation, can best be understood in reference to the accompanying drawings, in which like reference numerals refer to like parts, and in which:

FIG. 1 is a block diagram of an example system in accordance with present principles;

FIG. 2 is a block diagram of a part of the system shown in FIG. 1;

FIG. 3 is a flow chart of example logic for PUTs; and

FIG. 4 is a flow chart of example logic for GETs.

### DESCRIPTION OF EXAMPLE EMBODIMENTS OVERVIEW

As understood herein, peering among DHTs (e.g., peering among service providers implementing DHTs, as opposed to peering among individual clients within a single service provider's domain) can be achieved by broadcasting Put and Get messages (respectively, messages seeking to place data and messages seeking to obtain data) among the peered DHTs. If all DHTs are directly connected to all other DHTs then broadcasting is straightforward, but as understood herein, if the relationship between peering DHTs is more topologically complex so that some DHTs do not connect directly to other DHTs (as is the case with peering among multiple service providers), then flooding Put and Get messages is potentially expensive. Indeed, as further understood herein the requirement to replicate records in all other DHT rings greatly increases the number of records, placed by the broadcast PUT, in each DHT ring, which adversely impacts database lookup latency. Also, a broadcast GET message results in a lookup in every DHT ring, which increases messaging overhead. With these recognitions in mind, the description below is provided.

In a first embodiment, an apparatus has a processor in a first network in a system of networks. The networks in the system are not fully meshed with each other. A computer readable storage medium bears instructions to cause the processor to respond to storage of a piece of content by generating a content descriptor indicating a storage location of the content. The content is provided by a content provider that stores content in only a subset of networks in the system of networks. The content descriptor is sent only to the subset of networks while a descriptor of the subset of networks is published only to desired networks in the system of networks. The desired networks are defined by the content provider.

In examples, the descriptor of the subset of networks is published using a PUT. The content descriptor may be sent only to respective root nodes of the subset of networks using a multicast PUT. The system of networks can be an overlay distributed hash table (DHT) network, and if desired the descriptor of the subset of networks is published to the desired networks only when the subset of networks changes.

In non-limiting examples if content “a” is created by content provider “b” the content “a” is associated with an extensible resource indicator (xri) of the form xri://a.b. The xri can be hashed to generate the content descriptor key, Specifically, the content descriptor key may be generated by the operation hash(xri://a.b), with the descriptor of the subset of networks indexed by a the content provider key generated by hashing a content provider string in the xri. Specifically, the content provider descriptor key of the subset of networks may be generated by the operation hash(xri://b).

In another embodiment a tangible computer readable medium bears instructions executable by a computer processor associated with a node in an overlay network for receiving, from a requestor, a request for content from a content provider. In response to the request, an extensible resource identifier (xri) of the content is hashed to generate a content key, and a GET performed on the content key. If the content is available in the node, a content location descriptor for the content is retrieved and sent to the requester. Otherwise, a content provider identification (CPI) key is generated indicating a subset of storage nodes in the overlay network at which content from the content provider is stored. A GET on the CPI key is performed to obtain identifications of the subset of storage nodes and a GET of the content key is forwarded to nodes associated with the identifications of the subset of storage nodes.

In example embodiments the instructions may further cause the processor to retrieve from at least one node in the subset of storage nodes a respective content location descriptor indicating a respective resource from which to download the content. If the GETs fail the processor may generate a broadcast GET to all other peering nodes to find the content. If desired, the processor retrieving the content may publish the content location descriptor for the content in the local DHT indicating itself as the resource, thereby allowing further requests within the same DHT to find the content locally.

In another embodiment, a computer-implemented method contemplates PUTting a content location descriptor indicating an actual storage location of content from a content provider only to root distributed hash tables (DHT) associated with the content provider. The method includes PUTting a secondary key indicating a subset of DHT rings at which content from the content provider might be stored only to DHT rings for which the content provider desires the content to be available. When a GET for the content is received, it is determined from the content key whether the content can be provided locally and if not, identification information associated with the subset of DHT rings is obtained from the secondary key. The GET for the content is then forwarded to corresponding root DHTs.

### EXAMPLE EMBODIMENTS

The following acronyms and definitions are used herein:

Autonomous DHT (AD): a DHT operated independently of other DHTs, with the nodes in the AD serving the entire DHT ID keyspace.

Peering Gateway: a designated node in a DHT which has Internet Protocol (IP) connectivity to one or more Peering Gateways in other ADs and which forwards Puts, Gets, and the responses to Gets between the local DHT and the peer(s).

Origin or Home DHT: The DHT in which a piece of content is originally stored, which is the authoritative source for the content.

Present principles apply to one or more usage scenarios. For example, in one scenario multiple Autonomous Systems are provided within a single provider. More specifically, for operational reasons, a single service provider may choose to operate a network as a set of autonomous systems (AS). Each AS may be run by a different organization. These AS do not necessarily have to be true AS in the routing sense. For example, an AS may be an “Autonomous DHT” (AD). An Autonomous DHT is a group of nodes that form their own independent DHT ring and operate largely independently of other ADs. Each AD has access to the complete DHT ID space, but may or may not store content that is stored in other ADs. It is desirable in this case that content located in one AD can be selectively accessed from another. There are many variants of this scenario, such as a provider having one AD that hosts the provider's content and a number of ADs that serve different regions or different classes of customer (such as mobile, DSL, etc).

Another usage scenario is peering among providers, in which service providers who operate DHTs may wish to peer with each other. This scenario differs from the preceding case mainly in the fact that a high degree of co operation or trust among competing providers cannot be assumed. Thus, this scenario requires an appropriate level of isolation and policy control between providers. Variants of this scenario include providers whose main function is to host content, who then peer with providers whose main function is to connect customers to the content. Other variants may include providers who provide connectivity between small providers and “backbone” providers. In both of the above usage scenarios the graph of providers should not be assumed to have any particular structure.

Accordingly and turning now to FIG. 1, a system 10 of networks 12 is organized into a hierarchy that may be expected to develop among peering content providers. A strict hierarchy with only a single root among the networks 12 and with every network being the child of at most one parent network should not be assumed because such an assumption is too restrictive as a practical matter. Each network 12 may establish a distributed hash table (DHT).

As shown, each network 12 can be composed of respective plural DHT storage nodes 14 as shown. Each DHT storage node 14 may be a DHT per se or may be another DHT-like entity that supports the Put/Get interface of a DHT even though it may be implemented in some other way internally. In one example embodiment each network can serve puts and gets of any key in the full DHT keyspace.

Each network 12 includes a respective gateway node 16, discussed further below, that communicates with one or more gateway nodes of other networks 12. Thus, not all storage nodes 14 communicate with the other networks; rather, only the gateway nodes 16 of the various networks 12 communicate with other networks. Typically, a gateway 16 executes the logic below, although nodes 14 in a network 12 may execute all or part of the logic on behalf of network if desired.

In the example embodiment shown in FIG. 1, the networks 12 are labeled with the letters “A”-“F”, and FIG. 1 illustrates that a strict top-down hierarchy among networks 12 may not be implemented. Instead, as shown network “A” communicates directly with networks “B” and “C” and with no other networks, whereas network “B” communicates directly with networks “A”, “E”, and “F”. Networks “E” and “F” communicate with each other directly. Network “C”, in addition to communicating with network “A” directly as described above, communicates directly with only one other network, namely, network “D”, which communicates directly with no other network.

Thus, it may now be appreciated that peering among DHTs may be selective, just as peering among Internet service providers is selective. Thus, the graph of peering relationships among DHTs is arbitrary and not a full mesh, in that not every DHT communicates directly with every other DHT in the system 10, although all DHTs in the system may communicate with each other indirectly through other DHTs.

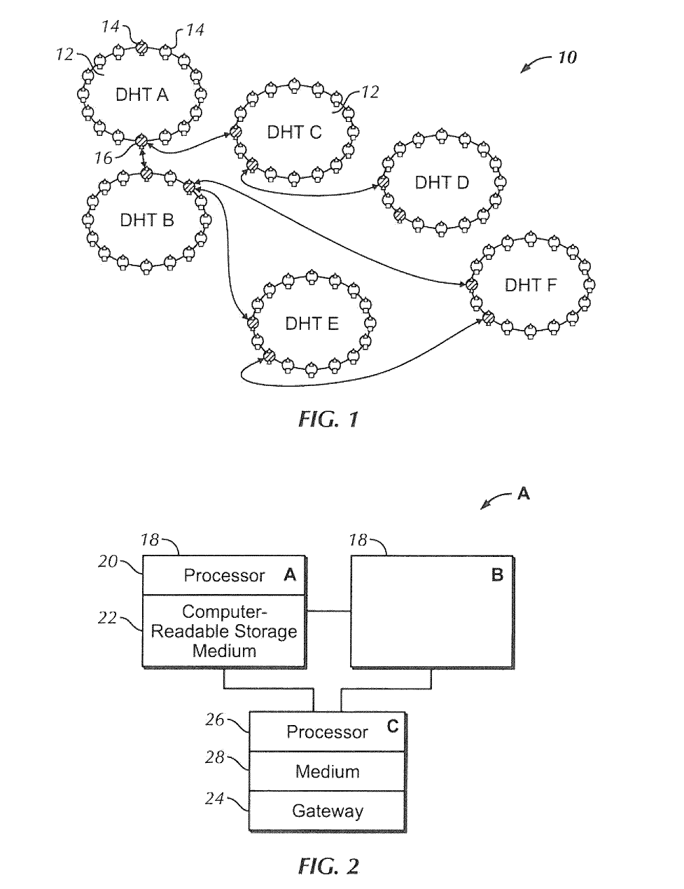

FIG. 2 shows a simplified view of a network, in this case, the network A from FIG. 1. As shown, a network may include plural members 18 (such as one of the above-described DHT storage nodes 14), each typically with one or more processors 20 accessing one or more computer-readable storage media 22 such as but not limited to solid state storage and disk storage. Typically, a network also includes at least one respective gateway 24 (such as the above-described gateway node 16) with its own processor 26 and computer readable storage media 28 that may embody present logic for execution thereof by the processor 26. Other parts of the logic may be implemented by one or more other members of the network. Network member 18 may include, without limitation, end user client devices, Internet servers, routers, switches, etc.

As an initial matter, data is stored in a DHT by performing a PUT (key, value) operation; the value is stored at a location, typically in one and only one DHT storage node, that is indicated by the fixed length key field of the PUT message. Data is retrieved using a GET (key) operation, which returns the value stored at the location indicated by the key field in the GET message. In a bit more detail, content is indexed by hashing an extensible resource identifier (xri) of the content to generate a key. The value of the key is a descriptor that contains locations where the content is stored (resources). The content can then be located by hashing this xri and performing a GET on the generated key to retrieve the descriptor and then downloading the content from the resources listed in the descriptor. In example embodiments a single, flat keyspace is common to all DHTs, and all DHTs can PUT and GET values indexed by keys in that keyspace.

Present principles recognize that the extensible resource identifier (xri) typically contains not just the name of the content but also additional information, including the identification of the content provider. As also recognized herein, the number of content providers is typically much smaller than the number of pieces of content, and it is likely that content providers and DHT operators (service providers) would enter into agreements for content publishing, meaning that a particular content provider would publish content in only a subset of DHT rings and moreover a subset that does not frequently change.

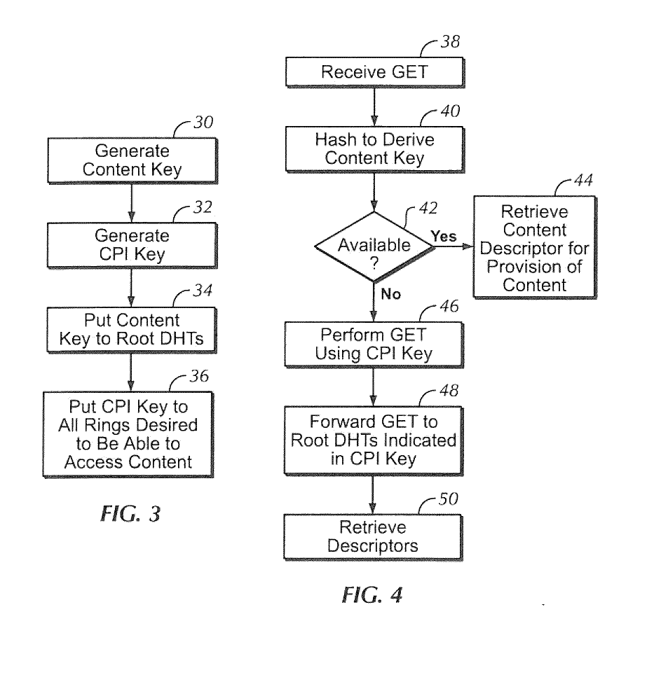

Accordingly and now turning to FIG. 3 content is published in an overlay network such as the one described above using not a broadcast PUT but rather a multicast PUT as follows. At block 30, the content provider/service provider hashes the xri of the content to generate a content key. Thus, for example, content “a” created by content provider “b” has an xri of the form xri://a.b, and the xri is hashed to generate a content key=hash(xri://a.b). The content key indicates an actual storage location of the content location descriptor.

At block 32, the content provider string embedded in the xri is hashed to generate a secondary key, referred to herein as the “content provider id” (“CPI”)key=hash(xri://b) The CPI key indexes a content provider descriptor which indicates a subset of storage nodes (e.g., DHT rings) in the overlay network at which content from the respective content provider might be stored. Stated differently, the CPI key indexes a descriptor with links pointing to DHTs where a content provider (in the above example, content provider “b”) has placed or expects to place content. These links may be the well-known peering nodes of these DHTs, similar to Border Gateways in BGP, or they may be ring identifications. In some embodiments the descriptor established by the CPI key may be different for different DHTs. For example, if DHT “C” has a special peering relationship with DHT “B”, then the descriptor (CPI key) published in DHT “C” may only contain the link to DHT “B”, thus facilitating complex peering relationships to exist on a per-content provider basis.

Moving to block 34, the first key (the content key) is PUT to at least one “root” DHT. The number of “root” DHTs is less than the total number of DHTs in the overlay network, and so the PUT at block 34 is not a broadcast PUT but rather only a multicast PUT. In essence, the first (content) key is PUT to root DHTs of the DHT rings that the particular service provider publishes in, and only to those root DHTs.

On the other hand, at block 36 the second key (the CPI key) is PUT to all DHT rings for which the content provider desires the content to be available. As understood herein, while the PUT at block 36 appears to be a broadcast PUT, the set of DHT rings that the content provider publishes in is unlikely to change frequently and thus this PUT operation is only necessary when the content provider wishes to add/delete a DHT ring from its list of searchable rings.

Thus, the descriptor represented by the CPI key establishes a policy mechanism for the content provider to control access to its content. The number of content-providers is expected to be far smaller than the number of content pieces and thus the number of content-provider descriptors is expected to incur small storage overhead.

Furthermore, while a multicast PUT of the content key is required to a content provider's “root” DHTs each time the content provider publishes a new piece of content or moves a piece of content, the PUT of the CPI key is not required until such time as the “root” DHTs of that content provider changes; i.e., until such time as the list of rings in which that content provider publishes content changes

FIG. 4 illustrates how content maybe retrieved in the overlay network described above using a multicast GET. At block 38, a node in a DHT handling a request for content hashes, at block 40, the full published xri of the content and performs a GET on the generated content key. If decision diamond 42 indicates that the content is available in the DHT, the descriptor for the content is retrieved at block 44. Otherwise (i.e., the GET fails at decision diamond 42), the logic flows to block 46 to perform a GET on the CPI key (derived in accordance with above principles), accordingly retrieving the list of DHTs where the content from that provider might be available. At block 48 the GET of the content key is forwarded via multicast to the “root” DHTs discovered at block 46. At block 50 one or more content location descriptors are retrieved indicating resources from which to download the content, with the descriptor(s) returned to the node originating the GET.

Thus, what is retrieved from the root DHTs is not the key but the descriptor which is indexed by the key, which, recall, is generated by bashing the xri of the content. The xri is made available to the requesting Service Node when the content is advertised via a portal.

In the event of stale CPI descriptors or a policy where peering DHTs do not supply content to a particular DHT, it may be possible for the GETs in FIG. 4 to fail. If this occurs, the node can resort to a broadcast GET to all other peering DHTs as a final attempt to find the content.

In some example implementations, as a further enhancement, based on policy, the node retrieving the content then publishes the descriptor for the content in its local DHT with itself as the resource, allowing further requests from the same DHT to find the content locally and avoid the multicast GET. The lifetime/refresh rate of this generated descriptor can depend on policy, enforced by the descriptor for the content-provider. For example, if the content-provider specifies “single-use” then this local descriptor will not be generated.

If desired, the node need not add its DHT as a possible “root” for the content provider, since the content provider would have done this already by adding it to the list of DHTs in the content-provider descriptor. This eliminates the need to republish the CPI descriptor in all DHTs as content is delivered from one DHT to another.

In some embodiments, the structure/content of the CPI key may be established to establish peering relationships, preference orders, usage limits and other policy details. For example, the CPI key can be used not only to establish the list of root nodes but also a preference as to the order in which the DHTs represented by the key are accessed, e.g., by ordering the root nodes from most preferred to least preferred.

While the particular LIMITING STORAGE MESSAGES IN PEER TO PEER NETWORK is herein shown and described in detail, it is to be understood that the subject matter which is encompassed by the present disclosure is limited only by the claims.

What is claimed is:

1. Apparatus comprising:
processor in a first network in a system of networks, the networks in the system not being fully meshed with each other;
computer readable storage medium bearing instructions to cause the processor to:
respond to storage of a piece of content by generating a content descriptor indicating a storage location of the content, the content being provided by a content provider storing content in a subset of networks in the system of networks, the subset of networks not being the entire system of networks;
send the content descriptor only to the subset of networks; and
publish a descriptor of the subset of networks only to desired networks in the system of networks apart from the subset of networks, the desired networks being defined by the content provider.

2. Apparatus of claim 1, wherein the descriptor of the subset of networks is published using a PUT.

3. Apparatus of claim 1, wherein the content descriptor is sent only to respective root nodes of the subset of networks using a multicast PUT.

4. Apparatus of claim 1, wherein the system of networks is an overlay distributed hash table (DHT) network.

5. Apparatus of claim 1, wherein the descriptor of the subset of networks is published to the desired networks only when the subset of networks changes.

6. Apparatus of Claim 1, wherein if content “a” is created by content provider “b” the content “a” is associated with an extensible resource indicator (xri) of the form xri://a.b, and the xri is hashed to generate the content descriptor using: hash(xri://a.b), the descriptor of the subset of networks being generated using: hash(xri://b).

7. A tangible computer readable medium bearing instructions executable by a computer processor associated with a node in an overlay network for:
receiving, from a requester, a request for content from a content provider;
hashing an extensible resource identifier (xri) of the content to generate a content key;
performing a GET on the content key;
if the content is available in the node, retrieving a content location descriptor for the content and sending the content location descriptor to the requestor; otherwise
generating a content provider identification (CPI) key indicating a subset of storage nodes in the overlay network at which content from the content provider is stored;
performing a GET on the CPI key to obtain identifications of the subset of storage nodes; and
forwarding a GET of the content key to nodes associated with the identifications of the subset of storage nodes.

8. The medium of claim 7, wherein the instructions further cause the processor to:
retrieve from at least one node in the subset of storage nodes a respective content location descriptor indicating a respective resource from which to download the content; and
return the content location descriptor(s) to the requester.

9. The medium of claim 8, wherein the overlay network is a DHT network.

10. The medium of claim 9, wherein the content location descriptor is forwarded to root DHTs in the subset of storage nodes.

11. The medium of claim 7, wherein if the GETs fail the processor generates a broadcast GET to all other peering nodes to find the content location descriptor.

12. The medium of claim 7, wherein the processor retrieving the content publishes the content location descriptor for the content locally indicating itself as the resource, thereby allowing further requests from the same requestor to find the content locally.

13. Computer-implemented method comprising:
PUTting a content key indicating an actual storage location of content from a content provider only to root distributed hash tables (DHT) associated with the content provider;
PUTting a secondary key indicating a subset of DHT rings at which content from the content provider might be stored only to DHT rings for which the content provider desires the content to be available;
when a GET for the content is received, determining from the content key whether the content can be provided locally and if not, obtaining identification information associated with the subset of DHT rings from the secondary key and forwarding the GET for the content to corresponding root DHTs.

14. The method of claim 13, wherein the method is executed by a processor in a gateway component of a DHT.

15. The method of claim 13, wherein if the GETs fail the method generates a broadcast GET to all other peering nodes to find the content.

16. The method of claim 13, comprising sending the content key using a multicast PUT.

17. The method of claim 13, comprising PUTting the secondary key only when the subset of DHT rings changes.

18. The method of claim 13, wherein if content “a” is created by content provider “b” the content “a” is associated with an extensible resource indicator (xri) of the form xri://a.b, and the xri is hashed to generate the content key having the form hash(xri://a.b), the secondary key being generated by hashing a content provider string in the xri to produce a descriptor of the form hash(xri://b).

19. The method of claim 13, wherein the secondary key is a content provider identification key.

20. The method of claim 13, wherein the content key is put each time the content provider publishes a new piece of content or moves a piece of content.
